(19) United States
(12) Patent Application Publication
(10) Pub. No.: US 2017/0034403 A1
(43) Pub. Date: Feb. 2, 2017

(54) METHOD OF IMAGING MOVING OBJECT AND IMAGING DEVICE

(71) Applicant: SAMSUNG ELECTRONICS CO., LTD., Suwon-si (KR)

(72) Inventors: Chang-woo SEO, Suwon-si (KR); Jae-ho LEE, Suwon-si (KR); Do-han KIM, Suwon-si (KR)

(21) Appl. No.: 14/941,971

(22) Filed: Nov. 16, 2015

(30) Foreign Application Priority Data
Jul. 30, 2015 (KR) 10-2015-0108144

(51) Int. Cl. H04N 5/14; H04N 5/265; G06T 7/20; H04N 5/235

(52) U.S. Cl. CPC H04N 5/145; H04N 5/2353; H04N 5/265; G06T 7/20

(57) ABSTRACT

An imaging device configured to image a moving object includes a sensing unit configured to obtain location information of the imaging device; a processor configured to determine a moving trajectory of the moving object using the location information; an interface configured to output a first image representing the moving trajectory; and an image processor configured to generate the first image and a second image representing the moving object based on the moving trajectory.

### CROSS-REFERENCE TO RELATED APPLICATION

This application is based on and claims priority under 35 U.S.C. §119 to Korean Patent Application No. 10-2015-0108144, filed on Jul. 30, 2015, in the Korean Intellectual Property Office, the disclosure of which is incorporated by reference herein in its entirety.

### BACKGROUND

1. Field

The disclosure relates to a method of imaging a moving object and an imaging device.

2. Description of Related Art

As technology related to imaging devices develops, imaging devices capable of capturing an image of high quality have been under development. When a star is imaged, an equatorial telescope mount or a star tracker (or a piggyback mount) is further necessary in addition to an imaging device. The equatorial telescope mount (or the piggyback mount) is a device for tracking a movement of the star. When the equatorial telescope mount (or the piggyback mount) and the imaging device are combined, the imaging device rotates based on a movement direction and a path of the star by the equatorial telescope mount (or the piggyback mount). Therefore, a user may capture a star image through the imaging device.

However, when the star image is captured according to the above-described method, much cost is consumed to provide the equatorial telescope mount (or the piggyback mount), and a complex process is necessary to combine the imaging device with the equatorial telescope mount (or the piggyback mount). Also, the user needs to have prior knowledge of a moving trajectory along which the star moves.

### SUMMARY

A method of imaging a moving object and an imaging device are provided. In addition, a computer readable recording medium recording a program causing a computer to execute the above-described method is also provided. Technical problems to be addressed are not limited to the above-described technical problems, and there may be other technical problems overcome by the disclosure.

According to an aspect of an example embodiment, an imaging device configured to image a moving object is provided, the imaging device including: a sensing unit including a sensor configured to obtain location information of the imaging device; a processor configured to determine a moving trajectory of the moving object using the location information; a user interface configured to output a first image representing the moving trajectory; and an image processor configured to generate the first image and a second image representing the moving object based on the moving trajectory.

The second image may include an image representing a moving trajectory of a star or an image representing a point image of the star.

The image processor may be configured to generate the first image by displaying the moving trajectory on a live view image including the moving object.

The image processor may be configured to generate the second image by combining still images captured based on a predetermined time interval and a predetermined exposure time.

The user interface may be configured to receive an input setting at least one of the time interval and the exposure time.

The user interface may be configured to output a live view image including the moving object and to receive an input selecting a first area in the live view image.

The image processor may be configured to select second areas other than the first area from still images including the moving object, and to generate the second image by synthesizing the second areas.

The image processor may be configured to select second areas other than the first area from still images including the moving object, to rotate the second areas in each of the still images based on the moving trajectory, and to generate the second image by synthesizing the rotated second areas. The processor may be configured to determine the moving trajectory of the moving object using the location information received from an external device.

The imaging device may further include a memory configured to store the moving trajectory, the first image and the second image.

According to an aspect of another example embodiment, a method of imaging a moving object using an imaging device is provided, the method including: obtaining location information of the imaging device; determining a moving trajectory of the moving object using the location information; outputting a first image representing the moving trajectory; and generating a second image representing the moving object based on the moving trajectory.

The second image may include an image representing a moving trajectory of a star or an image representing a point image of the star.

The method may further include generating the first image by displaying the moving trajectory on a live view image including the moving object.

The method may further include generating the second image by combining still images captured based on a predetermined time interval and a predetermined exposure time.

The method may further include receiving an input setting at least one of the time interval and the exposure time.

The method may further include receiving an input selecting a first area in a live view image including the moving object.

The method may further include selecting second areas other than the first area in still images including the moving object. Generating the second image may include generating the second image by synthesizing the second areas.

The method may further include selecting second areas other than the first area in still images including the moving object; and rotating the second areas in each of the still images based on the moving trajectory. Generating the second image may include generating the second image by synthesizing the rotated second areas.

In determining the moving trajectory, the moving trajectory of the moving object may be determined using the location information received from an external device.

According to an aspect of still another example embodiment, there is provided a non-transitory computer readable recording medium having stored thereon a computer program which, when executed by a computer, performs the method.

### BRIEF DESCRIPTION OF THE DRAWINGS

These and other aspects of the disclosure will become more readily apparent from the following detailed description, taken in conjunction with the accompanying drawings, in which like reference numerals refer to like elements, and wherein:

FIG. 1 is a diagram illustrating an example method of imaging a moving object.

FIG. 2 is a diagram illustrating an example configuration of an imaging device.

FIG. 3 is a flowchart illustrating an example method of imaging a moving object.

FIG. 4 is a sequence diagram illustrating an example in which an imaging device operates.

FIG. 5 is a diagram illustrating an example in which a sensing unit obtains location information of an imaging device.

FIG. 6 is a diagram illustrating an example in which a sensing unit obtains location information of an imaging device.

FIG. 7 is a diagram illustrating an example first image.

FIG. 8 is a diagram illustrating another example first image.

FIG. 9 is a flowchart illustrating another example method of imaging a moving object.

FIG. 10 is a sequence diagram illustrating an example in which an imaging device operates.

FIG. 11 is a diagram illustrating an example in which a user interface unit receives an input setting imaging conditions of an image.

FIG. 12 is a diagram illustrating another example in which a user interface unit receives an input setting imaging conditions of an image.

FIG. 13 is a diagram illustrating an example in which an image processing unit generates still images.

FIG. 14 is a diagram illustrating an example in which a user interface unit receives an input selecting a type of a second image.

FIG. 15 is a diagram illustrating an example in which a second image is generated.

FIG. 16 is a sequence diagram illustrating another example in which an imaging device operates.

FIG. 17 is a diagram illustrating an example in which a user interface unit receives an input selecting a non-rotation area.

FIG. 18 is a diagram illustrating another example in which a user interface unit receives an input selecting a non-rotation area.

FIG. 19 is a diagram illustrating another example in which a second image is generated.

FIG. 20 is a diagram illustrating another example configuration of an imaging device.

FIG. 21 is a diagram illustrating another example configuration of an imaging device.

FIG. 22 is a diagram illustrating another example configuration of an imaging device.

### DETAILED DESCRIPTION

Examples of the disclosure will be described in detail with reference to drawings. The following examples of the disclosure are provided to illustrate the disclosure, and do not restrict and limit the scope of the disclosure. Also, content that may be easily construed by those skilled in the art from descriptions and examples of the disclosure may be considered to be included in the disclosure.

Throughout this disclosure, when a certain part “includes” a certain component, it means that another component may be further included not excluding another component unless otherwise defined. Moreover, terms described in the specification such as “part” may refer, for example, to software or a hardware component such as a circuit, an FPGA or an ASIC, and the part performs certain functions. However, the “part” is not limited to software or hardware. The “part” may be configured in a storage medium that may be addressed or may be configured to be executed by at least one processor. Therefore, examples of the “part” include components such as software components, object-oriented software components, class components and task components, and processes, functions, attributes, procedures, subroutines, segments of program codes, drivers, firmware, micro codes, circuits, data, database, data structures, tables, arrays and variables. Components and functions provided from “parts” may be combined into a smaller number of components and “parts” or may be further separated into additional components and “parts.”

Throughout this disclosure, the term “gesture” may refer, for example, to a hand gesture or the like. For example, gestures described herein may include a tap, a touch and hold, a double tap, a drag, panning, a flick, a drag and drop, or the like.

The term “tap” may, for example, refer to an operation of touching a screen very quickly using a finger or a touch device (a stylus). For example, it may refer to a case in which a time difference between a touch-in point, which is a time point at which a finger or a touch device comes in contact with a screen, and a touch-out point, which is a time point at which the finger or the touch device is released from the screen, is very short.

The term “touch and hold” may, for example, refer to an operation of touching the screen using a finger or a touch device and then holding a touch input for a critical time or more. For example, it may refer to a case in which the time difference between the touch-in point and the touch-out point is a critical time or more. In order to indicate whether the touch input is a tap or a touch and hold, a visual or audible feedback signal may be provided when the touch input continues for the critical time or more.

The term “double tap” may, for example, refer to an operation of quickly touching the screen twice using a finger or a touch device.

The term “drag” may, for example, refer to an operation of touching the screen with a finger or a touch device, and then moving the finger or the touch device to another location in the screen while the finger or the touch device is still in contact with the screen. According to the drag operation, an object (for example, one image included in a thumbnail image) may be moved or a panning operation described below may be performed.

The term “panning” may, for example, refer to an operation of performing a drag operation without selecting an object. Since panning does not include selecting a specific object, the object is not moved in an interactive screen, but the interactive screen itself is advanced to the next page, or a group of the object is moved in the interactive screen.

The term “flick” may, for example, refer to an operation of dragging very quickly using a finger or a touch device. Based on whether a moving speed of the finger or the touch device is equal to or greater than a critical speed, it is possible to distinguish a drag (or panning) and a flick.

The term “drag and drop” may, for example, refer to an operation of dragging an object to a predetermined location in the screen using a finger or a touch device and then releasing.

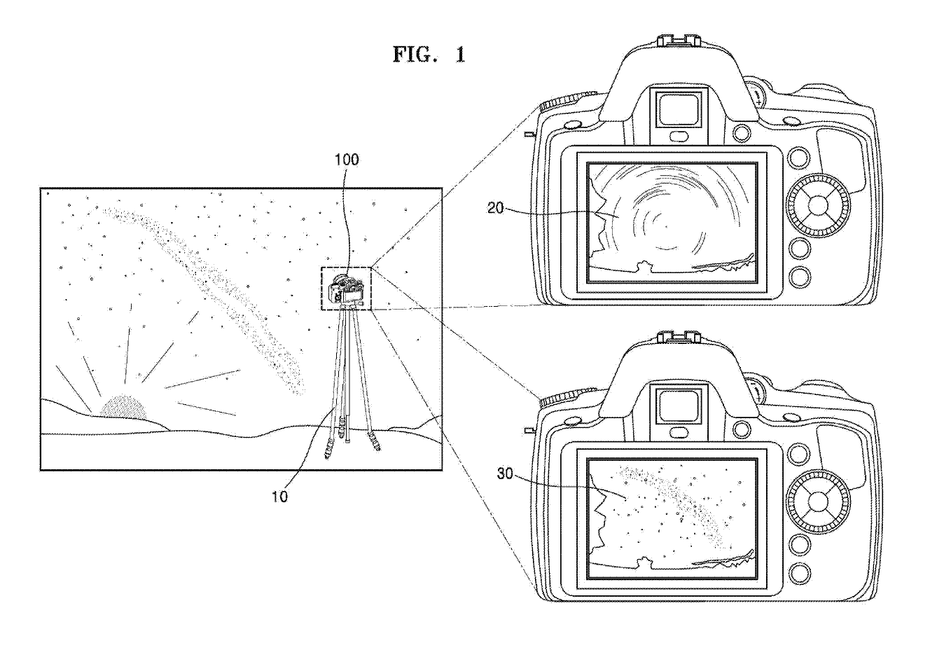

FIG. 1 is a diagram illustrating an example method of imaging a moving object.

In FIG. 1, an imaging device 100 and a tripod 10 supporting the imaging device are illustrated. Here, the imaging device 100 may, for example, be a device that is included in a camera or an electronic device and performs an imaging function. For example, the imaging device 100 may be a digital single lens reflex (DSLR) camera, a compact system camera, a camera installed in a smartphone, or the like.

The imaging device 100 may image a moving object. In this illustrative example, the moving object may, for example, be a star. Since the earth rotates about its own axis, when the star is observed from the ground, it is observed that the star moves about 15° per hour. In other words, the star observed from the ground may correspond to a moving object that moves along a moving trajectory.

In prior systems, generally, in order to image the star, in addition to a camera, an equatorial telescope mount or a star tracker (or a piggyback mount) is further necessary. The equatorial telescope mount (or the piggyback mount) is a device for tracking a movement of the star. When the equatorial telescope mount (or the piggyback mount) and the camera are combined, the camera rotates according to a movement direction and a path of the star by the equatorial telescope mount (or the piggyback mount). Therefore, the user may capture a star image through the camera.

However, when the star image is captured according to the above-described prior method, it is very expensive to provide the equatorial telescope mount (or the piggyback mount), and a complex process is necessary to combine the camera with the equatorial telescope mount (or the piggyback mount). Also, the user needs to have a prior knowledge of a moving trajectory along which the star moves.

The imaging device 100 according to the example of the disclosure may image the moving object while the imaging device 100 is fixed. Here, when it is described that the imaging device 100 is fixed, it may refer, for example, to a field of view (FOV) of a lens included in the imaging device 100 being fixed. For example, the imaging device 100 may image the moving object while the field of view of the lens is not changed. For example, the imaging device 100 may be combined with the tripod 10 fixed at a specific location and may image the moving object. Even when the imaging device 100 is not combined with the tripod 10, the user directly may, for example, grasp the imaging device 100, fix the imaging device 100, and image the moving object.

For example, the imaging device 100 may use location information of the imaging device 100, determine the moving trajectory of the moving object, and generate an image representing the moving object. For example, the imaging device 100 may determine the moving trajectory of the star and generate a star image. In this case, the star image may be an image (hereinafter referred to as a “trajectory image”) 20 representing the moving trajectory along which the star has moved with the passage of time or an image (hereinafter referred to as a “point image”) 30 representing a point image of the star.

The imaging device 100 may synthesize a plurality of still images that are captured at constant time intervals, generate the trajectory image 20 or the point image 30, and display the generated images 20 and 30. Also, the imaging device 100 may display the moving trajectory determined using the location information of the imaging device 100. The location information of the imaging device 100 may, for example, include an azimuth of an optical axis of the lens included in the imaging device 100, an altitude of the moving object, and latitude, longitude, and date and time information of the imaging device 100. The azimuth of the optical axis of the lens and the altitude of the moving object may, for example, refer to an azimuth and an altitude in a celestial sphere with respect to the imaging device 100.

According to the above description, the imaging device 100 may image the moving object while the imaging device 100 is fixed. Also, even when the imaging device 100 is not combined with an expensive device (for example, the equatorial telescope mount or the piggyback mount), the imaging device 100 may image the moving object. Additionally, without a prior knowledge of the moving trajectory of the moving object, the user may easily image the moving object using the imaging device 100.

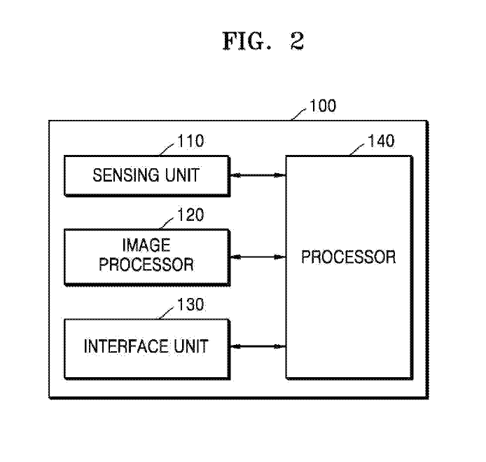

An example of the imaging device 100 will be described with reference to FIG. 2.

FIG. 2 is a diagram illustrating an example configuration of an imaging device.

As illustrated in FIG. 2, the imaging device 100 includes, for example, a sensing unit including at least one sensor 110, an image processing unit or image processor 120, an interface unit 130 and a processor 140. In the imaging device 100 illustrated in FIG. 2, only components related to the example are illustrated. Therefore, it will be understood by those skilled in the art that other general-purpose components may be further included in addition to the components illustrated in FIG. 2.

The sensing unit 110 includes at least one sensor and obtains the location information of the imaging device 100. The location information may, for example, include the azimuth of the optical axis of the lens included in the imaging device 100, the altitude of the moving object, and the latitude, longitude, and date and time information of the imaging device 100.

For example, the sensing unit 110 may include various sensors, including an azimuth meter, a clinometer and a GPS receiver. The azimuth meter may obtain information on the azimuth of the optical axis of the lens. The clinometer may obtain information on the altitude of the moving object. The GPS receiver may obtain information on a latitude and a longitude indicating a current location of the imaging device 100 and information on a current date and time.

The processor 140 may be configured to use the location information and determine the moving trajectory of the moving object. The moving trajectory may represent a direction and a distance in which the moving object moves with the passage of time, and may refer to a moving path in a current field of view of the lens of the imaging device 100. For example, when the moving object moves beyond the current field of view of the lens, the movement may not be included in the moving trajectory determined by the processor 140.

The processor 140 may generally be configured to control operations of components included in the imaging device 100. For example, the processor 140 may be configured to execute programs stored in a memory (not illustrated), and thus generally control the sensing unit 110, the image processor 120 and the interface unit 130.

The interface unit 130 may be configured to output an image representing the moving trajectory. For example, in the moving trajectory, a location change of the moving object based on a predetermined time interval may be displayed. In addition, a time at a start point of the moving trajectory and a time at an end point of the moving trajectory may be displayed.

The interface unit 130 may be configured to output an image representing the moving object. The interface unit 130 may also be configured to receive information on an input. For example, the interface unit 130 may, for example, include a display panel, an input and output device such as a touch screen and a software module configured to drive the same.

The image processor 120 may be configured to generate an image representing the moving trajectory. For example, the image processor 120 may be configured to display the moving trajectory on a live view image including the moving object and to thus generate an image representing the moving trajectory.

Also, the image processor 120 may be configured to generate an image representing the moving object. For example, the image processor 120 may be configured to generate a plurality of still images based on a predetermined time interval and a predetermined exposure time. The image processor 120 may be further configured to synthesize the still images and to generate an image representing the moving object. For example, the image processor 120 may synthesize the still images based on a synthesis parameter that is determined based on the location information of the imaging device 100.

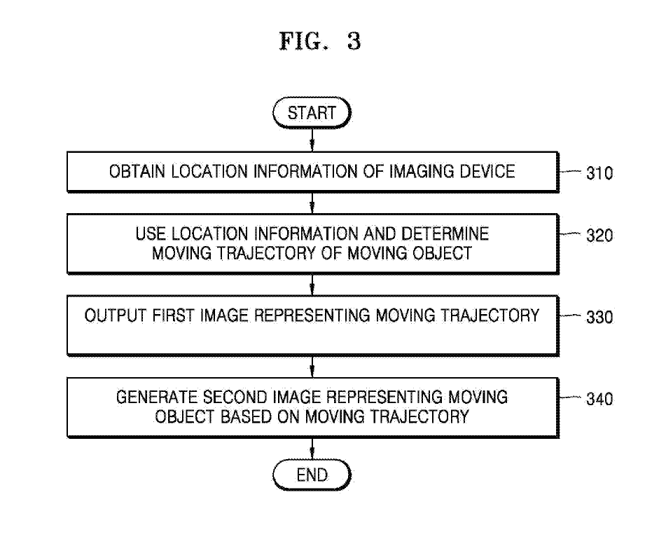

With reference to FIG. 3, an example method in which the imaging device 100 images the moving object will be described.

FIG. 3 is a flowchart illustrating an example method of imaging a moving object.

As illustrated in FIG. 3, the method of imaging the moving object includes operations that may, for example, be processed in time series in the imaging device 100 illustrated in FIGS. 1 and 2. Therefore, although not described below, it may be understood that the above-described content related to the imaging device 100 illustrated in FIGS. 1 and 2 is applicable to the method of imaging the moving object of FIG. 3.

In operation 310, the sensing unit 110 obtains the location information of the imaging device 100 via, for example, the various sensors included in the sensing unit. The location information may, for example, include the azimuth of the optical axis of the lens included in the imaging device 100, the altitude of the moving object, and the latitude, longitude, and date and time information of the imaging device 100.

In operation 320, the processor 140, based, for example, on the location information, is configured to determine the moving trajectory of the moving object. For example, the moving object may refer to a star, but the moving object is not limited thereto. For example, any object whose location is changed with the passage of time may be included in the moving object of the disclosure. The moving trajectory may, for example, represent a direction and a distance in which the moving object moves with the passage of time and may refer to a moving path in the current field of view of the lens of the imaging device 100.

In operation 330, the interface unit 130 may output a first image representing the moving trajectory. For example, in the first image, a location change of the moving object based on a predetermined time interval may be displayed. In addition, in the first image, a time at a start point of the moving trajectory and a time at an end point of the moving trajectory may be displayed.

In operation 340, the image processor 120 may be configured to generate a second image representing the moving object based on the moving trajectory. For example, when it is assumed that the moving object is a star, the second image may be a trajectory image of the star or a point image of the star.

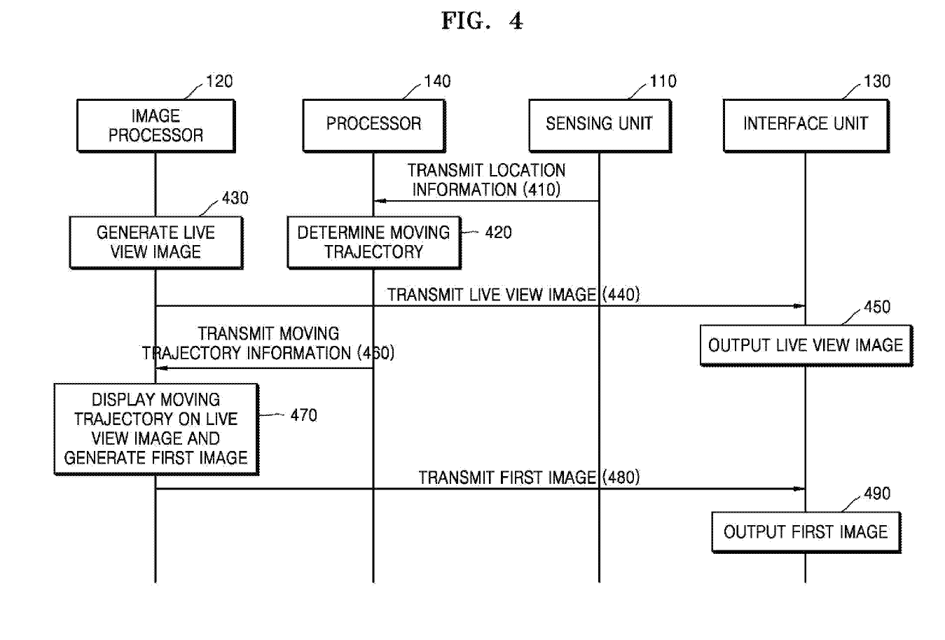

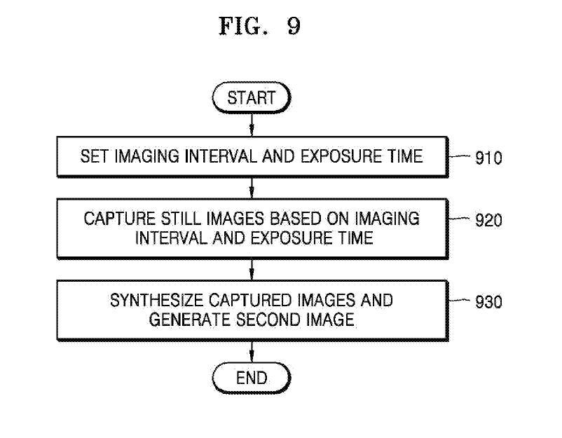

With reference to FIGS. 4 to 8, the above-described operations 310 to 330 will be described in detail. Also, with reference to FIGS. 9 to 19, the above-described operation 340 will be described in detail.

FIG. 4 is a sequence diagram illustrating an example in which an imaging device operates.

In FIG. 4, an example in which the sensing unit 110, the image processor 120, the interface unit 130 and the processor 140 included in the imaging device 100 operate will be illustratively described.

In operation 410, the sensing unit 110 obtains the location information of the imaging device 100 and transmits the location information of the imaging device 100 to the processor 140. In addition, although not illustrated in FIG. 4, the sensing unit 110 may be configured to store the location information of the imaging device 100 in the memory.

For example, the sensing unit 110 may be configured to obtain the location information of the imaging device 100 through various sensors, such as, for example, the azimuth meter, the clinometer and the GPS receiver included in the sensing unit 110. Alternatively, the sensing unit 110 may be configured to use location information transmitted from an external device near the imaging device 100 as the location information of the imaging device 100. Alternatively, the location information of the external device may be directly input to the imaging device 100, and the sensing unit 110 may use the input location information as the location information of the imaging device 100. For example, when the azimuth, altitude and GPS information are input through the interface unit 130, the sensing unit 110 may consider the input information as the location information of the imaging device 100.

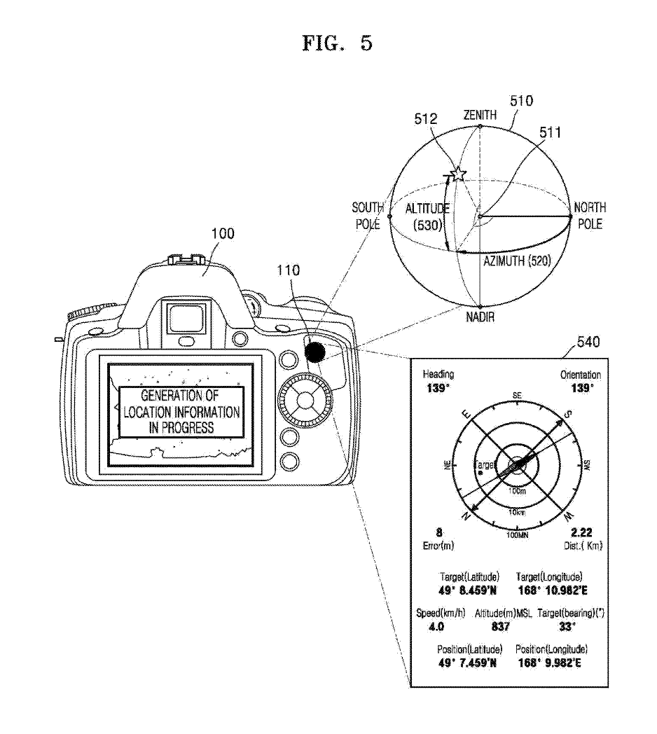

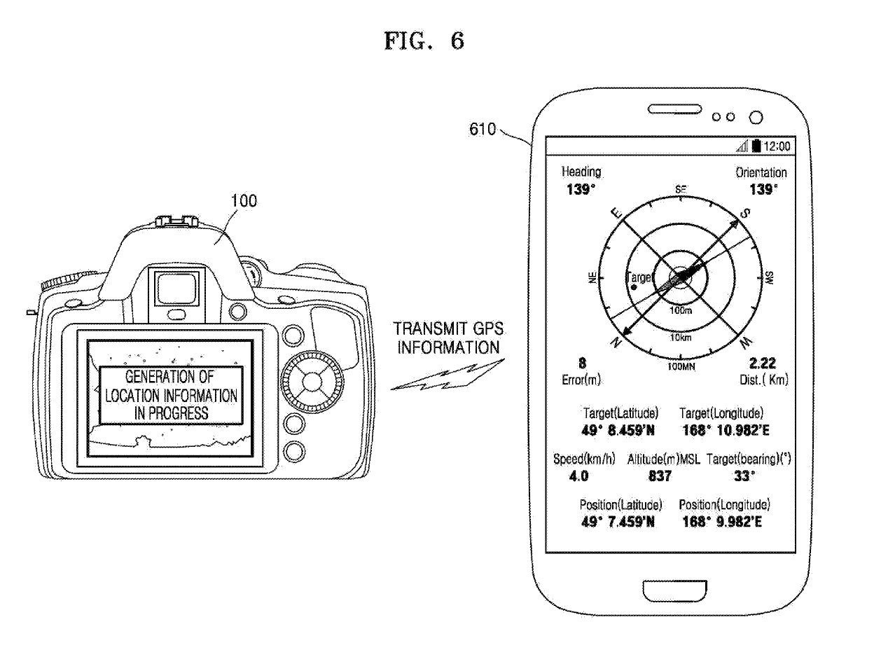

With reference to FIGS. 5 and 6, examples in which the sensing unit 110 obtains the location information of the imaging device 100 will be described.

FIG. 5 is a diagram illustrating an example in which a sensing unit obtains location information of an imaging device.

In FIG. 5, examples of the imaging device 100 and the sensing unit 110 included in the imaging device 100 are illustrated. The sensing unit 110 has a location that is not limited to a location illustrated in FIG. 5 and may be included in another part of the imaging device 100.

The sensing unit 110 is configured to obtain the location information of the imaging device 100 via various sensors included in the sensing unit 110. For example, the azimuth meter included in the sensing unit 110 may obtain information on an azimuth 520 of the optical axis of the lens. The clinometer included in the sensing unit 110 may obtain information on an altitude 530 of, for example, a star 512. Also, the GPS receiver included in the sensing unit 110 obtains GPS information 540 corresponding to the current location of the imaging device 100. The GPS information 540 may, for example, included information on a latitude and a longitude corresponding to the current location of the imaging device 100 and information on a current date and time.

The azimuth 520 of the optical axis of the lens refers, for example, to a horizontal angle that is measured from a north point of the celestial sphere 510 to the star 512 in, for example, a clockwise direction when an imaginary celestial sphere 510 is formed based on a current location 511 of the imaging device 100 and a direction in which the lens of the imaging device 100 faces the star 512. When the imaging device 100 is fixed such that the star 512 is included in the field of view of the lens, the azimuth meter included in the sensing unit 110 may obtain information on the azimuth 520 of the optical axis of the lens.

The altitude 530 of the star 512 refers to a vertical angle (height) that is measured from the horizon of the celestial sphere 510 to the star 512. For example, the altitude 530 of the star 512 may be a tilt angle formed by a surface of the celestial sphere 510 and the optical axis of the lens. When the imaging device 100 is fixed such that the star 512 is included in the field of view of the lens, the clinometer included in the sensing unit 110 may obtain information on the altitude 530 of the star 512.

In addition, the GPS receiver included in the sensing unit 110 receives the GPS information 540 corresponding to the current location 511 of the imaging device 100. The GPS information 540 includes, for example, information on a latitude and a longitude corresponding to the current location 511 of the imaging device 100 and information on a current date and time.

In the sensing unit 110, at least one of the azimuth meter, the clinometer and the GPS receiver may not be included. In this case, the sensing unit 110 may, for example, use the location information transmitted from the external device as the location information of the imaging device 100. For example, when the GPS receiver is not included in the sensing unit 110, the sensing unit 110 may consider GPS information transmitted from the external device as GPS information of the imaging device 100.

With reference to FIG. 6, an example in which the sensing unit 110 uses the GPS information transmitted from the external device as the GPS information of the imaging device 100 will be described.

FIG. 6 is a diagram illustrating an example in which a sensing unit obtains location information of an imaging device.

In FIG. 6, the imaging device 100 and an external device 610 are illustrated. For example, the external device 610 may be a smartphone, but the external device 610 is not limited thereto. As long as a device is capable of receiving GPS information, the device may be the external device 610 without limitation.

The imaging device 100 may, for example, receive GPS information from the external device 610. The sensing unit 110 may use the received GPS information as GPS information of the imaging device 100. In this case, the external device 610 may, for example, be located near the imaging device 100.

The imaging device 100 may receive GPS information from the external device 610 through a wired or wireless communication method. For example, the imaging device 100 may include a wired communication interface and/or a wireless communication interface. The imaging device 100 may receive GPS information from the external device 610 through at least one of the above-described interfaces.

The wired communication interface may, for example, include a Universal Serial Bus (USB), but the interface is not limited thereto.

The wireless communication interface may, for example, include a Bluetooth communication interface, a Bluetooth low energy (BLE) communication interface, a short-range wireless communication interface, a Wi-Fi communication interface, a Zigbee communication interface, an infrared Data Association (IrDA) communication interface, a Wi-Fi Direct (WFD) communication interface, an Ultra-wideband (UWB) communication interface, an Ant+ communication interface or the like, but the interface is not limited thereto.

Referring again to FIG. 4, in operation 420, the processor 140 determines the moving trajectory of the moving object. For example, when the moving object is assumed as a star, the processor 140 may be configured to determine the moving trajectory representing a direction and a distance in which the star moves with the passage of time. Additionally, although not illustrated in FIG. 4, the processor 140 may be configured to store the determined moving trajectory in the memory.

A sky that may by observed by the user through the lens of the imaging device 100 may be a part of the celestial sphere 510 illustrated in FIG. 5. For example, only one area of the celestial sphere 510 may be included in the field of view of the lens. A path along which the star moves on the celestial sphere 510 at a specific day and a specific time point is determined in advance. For example, a path along which the star moves in due north, due east, due south or due east of the celestial sphere 510 may be previously known. Therefore, when GPS information of the current location of the imaging device 100 is known, it is possible to know a path along which the star moves on the celestial sphere 510. However, the moving trajectory of the star in the field of view of the lens may be changed according to the azimuth and the altitude. Therefore, in order to determine the moving trajectory of the star included in the field of view of the lens, information on the azimuth of the optical axis of the lens and the altitude of the moving object is necessary.

The processor 140 may be configured to use location information transmitted from the sensing unit 110 and determine the moving trajectory. The location information includes, for example, the azimuth of the optical axis of the lens, the altitude of the moving object and a latitude and a longitude representing the current location of the imaging device 100. The processor 140 may know information on a moving distance of the star per hour in advance. Therefore, the processor 140 may be configured to determine a direction and a moving distance of the star included in the current field of view of the lens with the passage of time. For example, the processor 140 may be configured to determine the moving trajectory of the star in the current field of view of the lens.

In operation 430, the image processor 120 is configured to generate the live view image. The live view image may, for example, refer to an image corresponding to the current field of view of the lens. While FIG. 4 illustrates a case in which the sensing unit 110 transmits the location information of the imaging device 100 to the processor 140, and then the image processor 120 generates the live view image, the disclosure is not limited thereto. For example, the image processor 120 may be configured to generate the live view image regardless of operations of the sensing unit 110 and/or the processor 140.

In operation 440, the image processor 120 transmits the generated live view image to the interface unit 130.

In operation 450, the interface unit 130 outputs the live view image. For example, the live view image may be output on a screen included in the interface unit 130.

In operation 460, the processor 140 transmits information on the moving trajectory to the image processor 120.

In operation 470, the image processor 120 displays the moving trajectory on the live view image and thus generates the first image. For example, the image processor 120 may be configured to perform alpha blending and thus generate the first image.

In this case, in the first image, a location change of the moving object based on a predetermined time interval may be displayed. Also, in the first image, a time at a start point of the moving trajectory and a time at an end point of the moving trajectory may be displayed.

The image processor 120 may be configured to generate the first image using only the moving trajectory. For example, the image processor 120 may be configured to generate the first image including only the moving trajectory of the moving object without displaying the moving trajectory on the live view image. Also, although not illustrated in FIG. 4, the image processor 120 may be configured to store the first image in the memory.

In operation 480, the image processor 120 transmits the first image to the interface unit 130.

In operation 490, the interface unit 130 outputs the first image. For example, the first image may be output on a screen included in the interface unit 130.

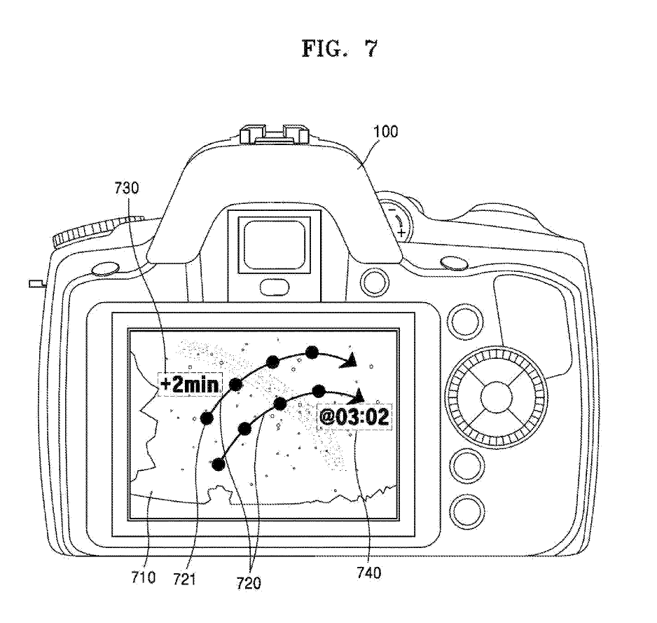

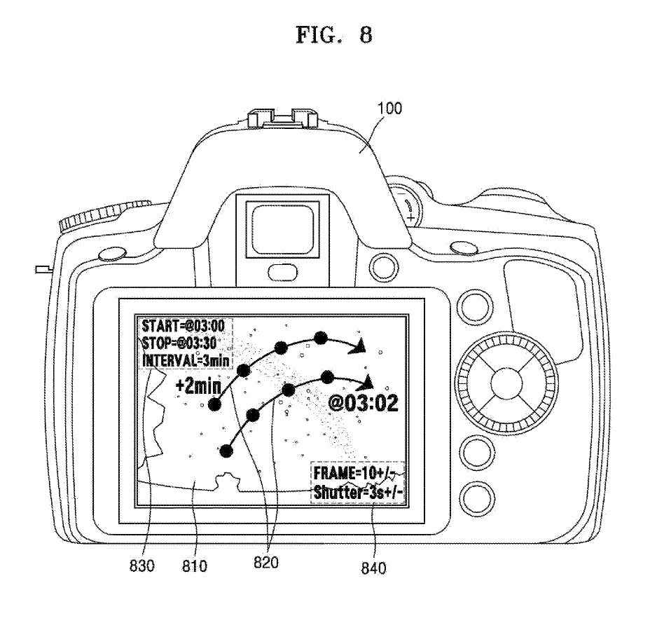

With reference to FIGS. 7 and 8, examples in which the first image is output to the interface unit 130 will be described.

FIG. 7 is a diagram illustrating an example first image.

As illustrated in FIG. 7, in the imaging device 100, the first image in which a moving trajectory 720 of the moving object is displayed on a live view image 710 is output.

The imaging device 100 is configured to generate an image representing the moving object based on the current field of view of the lens. For example, while the location and the field of view of the lens of the imaging device 100 are fixed, the imaging device 100 generates the image representing the moving object that moves with the passage of time. Therefore, the moving trajectory 720 shows a movement of the moving object (for example, the star) included in the current field of view of the lens with the passage of time.

In the first image, a location change of the moving object based on a predetermined time interval may be displayed. For example, on the moving trajectory 720, a location 721 of the moving object that moves for each predetermined time interval may be displayed. In the first image, an indication 730 showing a time interval of 2 minutes may be output. However, the example in which the location change of the moving object is displayed every 2 minutes is only an example. In the first image, a moving location change of the moving object may be displayed based on a shorter time interval or a longer time interval.

Also, in the first image, a time at a start point of the moving trajectory and/or a time at an end point of the moving trajectory may be displayed. For example, in the first image, an indication 740 showing that a time at an end point of the moving trajectory 720 is 3:02 am may be output. For example, in the first image, the indication 740 showing that the moving object may be observed to 3:02 am according to the current field of view of the lens may be output.

Therefore, the user may identify a path along which the moving object moves through the first image, and identify a location of the moving object for each predetermined time interval (for example, 2 minutes). Also, the user may recognize a time period for which the moving object may be observed according to the current field of view of the lens.

FIG. 8 is a diagram illustrating another example first image.

As illustrated in FIG. 8, in the imaging device 100, the first image in which a moving trajectory 820 of the moving object is displayed is output onto a live view image 810.

When the first image of FIG. 7 is compared with the first image of FIG. 8, in the first image of FIG. 8, conditions 830 and 840 necessary for the imaging device 100 to perform imaging are further displayed. As will be described below with reference to FIG. 9, the imaging device 100 is configured to perform imaging in the current field of view of the lens. For example, the imaging device 100 performs imaging for each predetermined time interval, and various conditions such as a predetermined shutter exposure time may be applied for each imaging.

For example, the imaging device 100 may perform imaging at the intervals of 3 minutes, and a shutter speed of 3 seconds may be set for each imaging. Also, a time period for which the imaging device 100 performs imaging may be set from 3:00 am to 3:30 am.

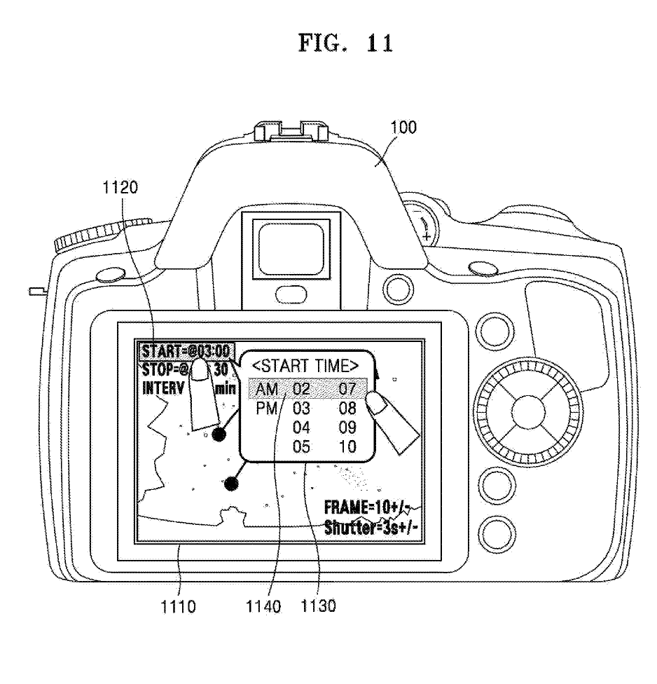

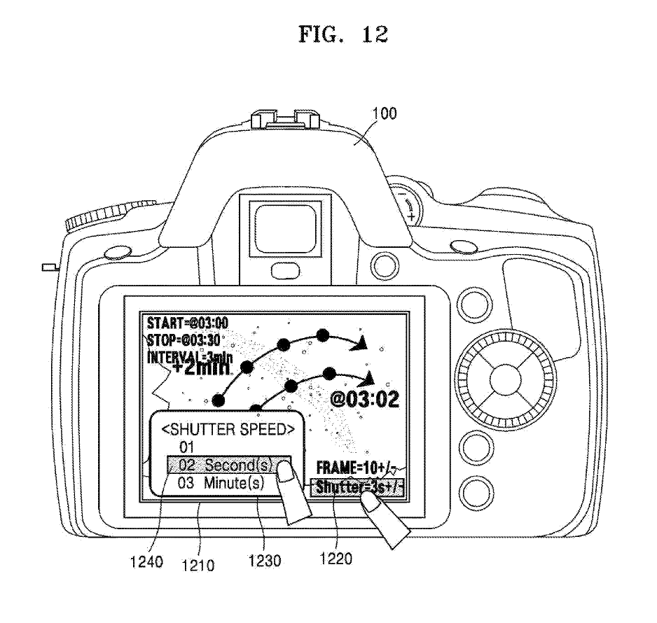

In the first image, in addition to the moving trajectory 820 of the moving object, the conditions 830 and 840 necessary for the imaging device 100 to perform imaging may be further displayed. In this case, the conditions 830 and 840 may be conditions that are set in the imaging device in advance. Therefore, the user may determine whether the field of view of the lens is changed with reference to the moving trajectory 820, and it is possible to check the imaging conditions 830 and 840 of the still image. Also, as will be described below with reference to FIGS. 11 and 12, the user may arbitrarily change the imaging conditions 830 and 840.

According to the above described with reference to FIGS. 4 to 8, the imaging device 100 may be configured to determine the moving trajectory of the moving object and display an image representing the moving trajectory. Therefore, the user may change an imaging composition of the imaging device 100 with reference to the moving trajectory displayed in the imaging device 100.

As described above with reference to operation 340 of FIG. 3, the imaging device 100 generates the second image representing the moving object based on the moving trajectory of the moving object. The second image may be the trajectory image of the moving object or the point image of the moving object. With reference to FIGS. 9 to 19, examples in which the imaging device 100 generates the second image representing the moving object will be described.

FIG. 9 is a flowchart illustrating an example method of imaging a moving object.

As illustrated in FIG. 9, a method of imaging the moving object includes operations that may, for example, be processed in time series in the imaging device 100 illustrated in FIGS. 1 and 2. Therefore, although not described below, it may be understood that the above-described content related to the imaging device 100 illustrated in FIGS. 1 and 2 may be applicable to the method of imaging the moving object of FIG. 9.

In operation 910, the image processor 120 sets an imaging interval and an exposure time. For example, the image processor 120 may set a time interval at which the still image will be captured and set a shutter exposure time to be applied for each imaging. For example, the image processor 120 may be configured to maintain the imaging interval and exposure time preset in the imaging device 100, and to change the preset imaging interval and exposure time based on an input.

In operation 920, the imaging device 100 captures still images based on the imaging interval and the exposure time.

In operation 930, the image processor 120 synthesizes the captured images and generates the second image. For example, the processor 140 is configured to generate the synthesis parameter based on whether the second image is the trajectory image or the point image. The image processor 120 is configured to synthesize the still images based on the synthesis parameter and to generate the second image.

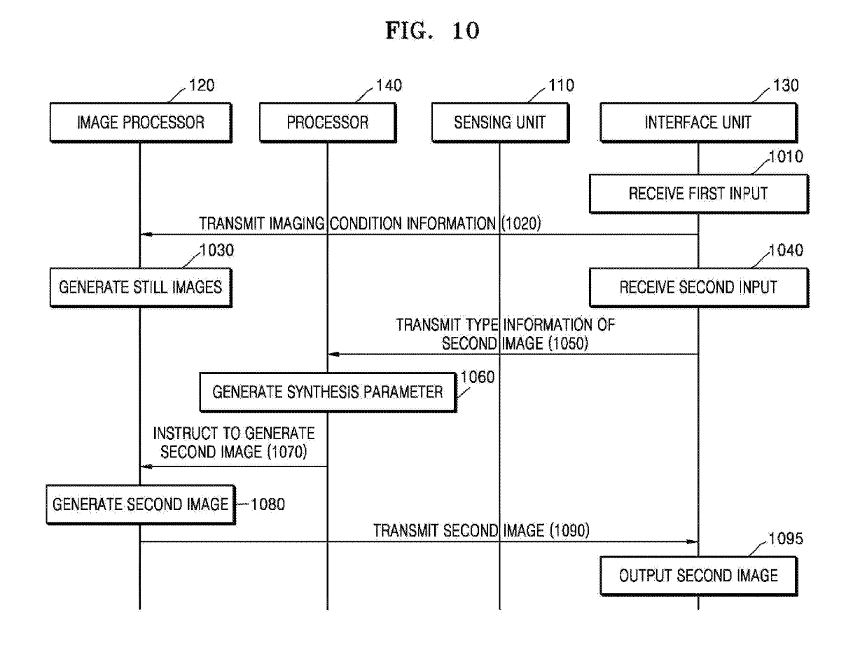

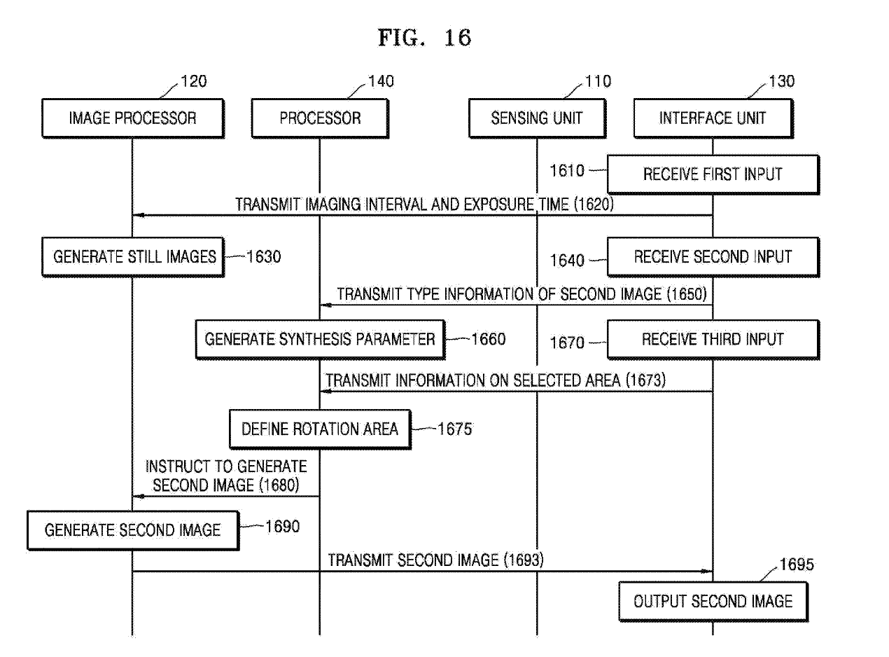

With reference to FIGS. 10 to 19, the above-described operations 910 to 930 will be described in more detail. For example, with reference to FIGS. 10 to 15, an example in which the image processor 120 generates the trajectory image will be described. With reference to FIGS. 16 to 19, an example in which the image processor 120 generates the point image will be described.

FIG. 10 is a sequence diagram illustrating an example in which an imaging device operates.

In FIG. 10, an example in which the sensing unit 110, the image processor 120, the interface unit 130 and the processor 140 included in the imaging device 100 operate is illustrated.

In operation 1010, the interface unit 130 receives a first input. The first input may, for example, refer to an input that is used to set conditions necessary for the imaging device 100 to capture still images. For example, a gesture may be input via the touch screen and set the above-described conditions, or a mouse or a keyboard connected to the imaging device 100 may be used to set the above-described conditions.

With reference to FIGS. 11 and 12, examples in which the interface unit 130 receives the first input will be described.

FIG. 11 is a diagram illustrating an example in which an interface unit receives an input for setting imaging conditions of an image.

As illustrated in FIG. 11, in the first image, in addition to the moving trajectory of the moving object, conditions necessary for the imaging device 100 to perform imaging are displayed. As above described with reference to FIG. 8, conditions necessary for imaging the still image may be set in the imaging device 100 in advance and the preset conditions may be displayed in the first image.

The preset imaging conditions of the imaging device 100 may be changed. For example, when it is assumed that the first image is output on a touch screen 1110, a gesture may be performed on the touch screen 1110 and change the imaging conditions.

For example, a time point at which capturing of the still image starts may be changed. When a touch (for example, a tap or a double tap) to an area 1120 to which a start time point of imaging is output on the touch screen 1110, a change of the start time point may be requested by the imaging device 100. When the touch of the area 1120 is detected, a window 1130 for changing the start time point may be output on the touch screen 1110. The window 1130 may, for example, be dragged, and thus change the start time point of imaging.

FIG. 12 is a diagram illustrating an example in which an interface unit receives an input for setting imaging conditions of an image.

As illustrated in FIG. 12, in the first image, in addition to the moving trajectory of the moving object, conditions necessary for the imaging device 100 to perform imaging are displayed. The imaging conditions preset in the imaging device 100 may be changed. For example, when it is assumed that the first image is output to a touch screen 1210, a gesture may be performed on the touch screen 1210 and change the imaging conditions.

For example, the shutter speed when the still image is captured may be changed. When a touch (for example, a tap or a double tap) in an area 1220 to which the shutter speed is output on the touch screen 1210 is detected, a change of the shutter speed may be requested by the imaging device 100. When the area 1220 is touched, for example, a window 1230 for changing the shutter speed may be output on the touch screen 1210. The window 1230 may be dragged and thus change the start time point of imaging.

As the shutter speed decreases, a time for which the shutter is open increases. Therefore, as the shutter speed decreases, the imaging device 100 receives a greater amount of light. However, since the moving object moves with the passage of time, a shape of the moving object may be distorted in the still image when the shutter speed decreases. For example, in the still image captured while the shutter speed decreases, the moving object may be represented as a flow or a streak.

When the shutter speed is changed, the imaging device 100 may display a range of the shutter speed at which the shape of the moving object is not distorted on the touch screen 1210. Therefore, an appropriate shutter speed with reference to the range of the shutter speed output to the touch screen 1210 may be set.

FIGS. 11 and 12 illustrate examples in which the start time point of imaging and the shutter speed are changed. However, according to the method described with reference to FIGS. 11 and 12, the other imaging conditions (for example, the end time point of imaging, the imaging interval, and the number of frames) may also be changed.

Referring again to FIG. 10, in operation 1020, the interface unit 130 transmits imaging condition information to the image processor 120. Operation 1020 is performed, for example, only when an input for changing the preset imaging condition is received. For example, when the imaging condition preset in the imaging device without change is accepted, the image processor 120 performs operation 1030 based on the preset imaging condition. For example, the imaging device 100 outputs a window asking whether to change the preset imaging condition to the user interface unit 130. When an input indicating acceptance of the preset imaging condition is received through the output window, the image processor 120 may perform operation 1030 based on the preset imaging condition.

In operation 1030, the image processor 120 generates still images. For example, the image processor 120 may generate the still images based on the imaging condition. The image processor 120 may also store the generated still images in the memory.

Although not illustrated in FIG. 10, the image processor 120 may continuously generate the live view image before operation 1030 is performed. For example, the imaging device 100 may continuously capture the live view image before the still images are captured, and display the captured live view image through the interface unit 130.

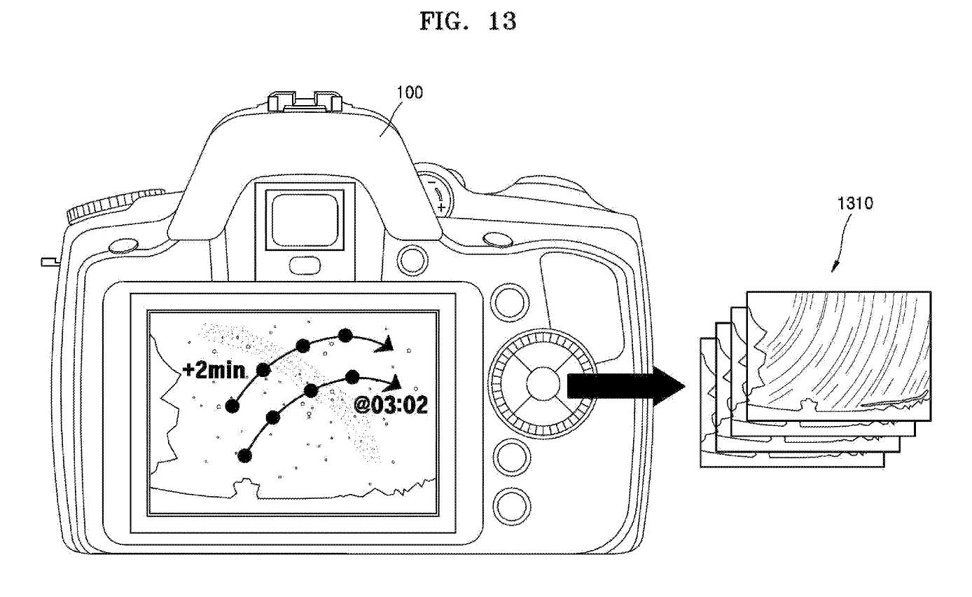

With reference to FIG. 13, an example in which the image processing unit 120 generates still images will be described.

FIG. 13 is a diagram illustrating an example in which an image processor generates still images.

The imaging device 100 may perform imaging based on the preset imaging conditions or imaging conditions set by the user. For example, when the imaging conditions in which “a start time point is 3:00 am, an end time point is 3:30 am, a time interval is 3 minutes, and a shutter speed is 3 seconds” are assumed, the imaging device 100 performs imaging every 3 minutes from 3:00 am to 3:30 am. Also, the shutter speed for each imaging remains at 3 seconds.

The image processor 120 generates still images 1310 based on imaging of the imaging device 100. In the above example, the imaging device 100 performs imaging every 3 minutes from 3:00 am to 3:30 am, and therefore 11 still images 1310 in total may be generated.

Although not illustrated in FIGS. 10 and 11, the interface unit 130 may display the still images 1310.

Referring again to FIG. 10, in operation 1040, the interface unit 130 receives a second input. Here, the second input may refer to an input of determining a type of the image representing the moving object. For example, the trajectory image or the point image may be selected through the second input. For example, a gesture may be input to the touch screen and select the trajectory image or the point image, or a mouse or a keyboard connected to the imaging device 100 may be used to select the trajectory image or the point image.

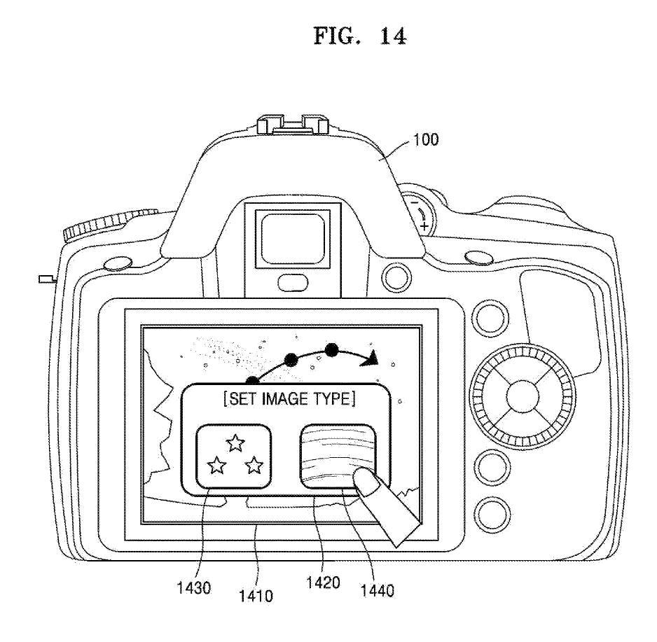

With reference to FIG. 14, an example in which the interface unit 130 receives the second input will be described.

FIG. 14 is a diagram illustrating an example in which an interface unit receives an input for selecting a type of a second image.

As illustrated in FIG. 14, on a touch screen 1410 of the imaging device 100, a window 1420 for requesting selection of a type of the second image may be output. In the window 1420, an icon 1430 indicating the point image and an icon 1440 indicating the trajectory image may be displayed. Any of the icons 1430 and 1440 may be selected.

For example, when any of the icons 1430 and 1440 displayed on the touch screen 1410 are touched (for example, a tap or a double tap), the point image or the trajectory image may be selected.

After any of the icons 1430 and 1440 are touched, a window for asking whether the selected image is correct may be output on the touch screen 1410. Therefore, the user may check again the type of the image selected.

Referring again to FIG. 10, in operation 1050, the interface unit 130 transmits type information of the second image to the processor 140. For example, the interface unit 130 transmits information indicating that an image selected is the point image or the trajectory image to the processor 140.

In operation 1060, the processor 140 generates the synthesis parameter. FIG. 10 illustrates an example in which the imaging device 100 generates the trajectory image of the moving object. Therefore, in operation 1060, the processor 140 generates the synthesis parameter for generating the trajectory image.

For example, the processor 140 may be configured to generate the synthesis parameter for overlaying still images. For example, the processor 140 may be configured to overlay pixels having the same coordinates in still images and to generate the synthesis parameter for generating one image.

The imaging device 100 captures still images at different times while a composition thereof is fixed. Therefore, when the still images are overlaid, an image representing a trajectory along which the moving object moves may be generated. For example, the processor 140 may be configured to generate the synthesis parameter for overlaying still images and thus the trajectory image of the moving object may be generated.

In operation 1070, the processor 140 is configured to instruct the image processor 120 to generate the second image. For example, the processor 140 is configured to transmit an instruction to synthesize the still images according to the synthesis parameter and to thus generate the second image to the image processor 120.

In operation 1080, the image processor 120 generates the second image. For example, the image processor 120 may be configured to extract pixels having the same coordinates from each of the still images, and to generate the second image using a method of overlaying the extracted pixels. Although not illustrated in FIG. 10, the image processor 120 may be configured to store the second image in the memory.

In operation 1090, the image processor 120 transmits the second image to the interface unit 130.

In operation 1095, the interface unit 130 outputs the second image. For example, the second image may be output on a screen included in the interface unit 130.

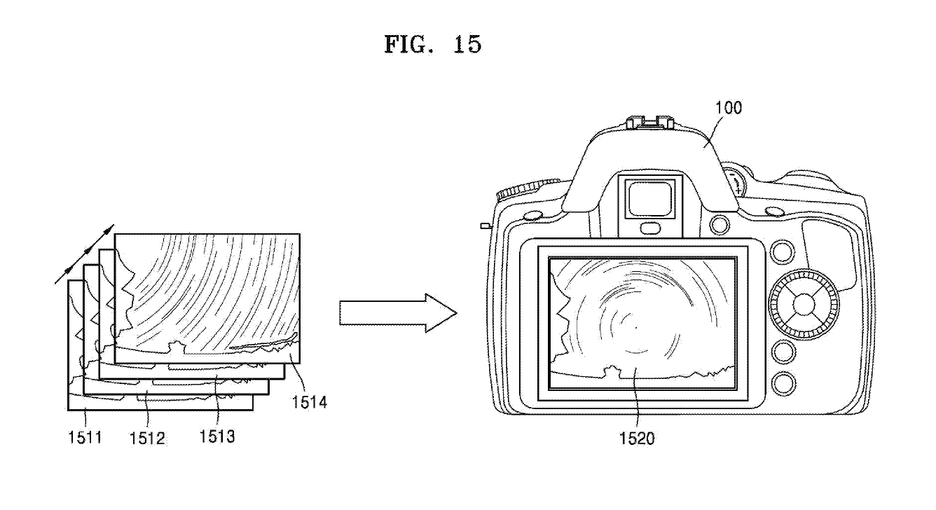

With reference to FIG. 15, the above-described operations 1080 to 1095 will be described in greater detail.

FIG. 15 is a diagram illustrating an example in which a second image is generated.

FIG. 15 illustrates still images 1511, 1512, 1513, and 1514 and a second image 1520 generated by the image processor 120. In FIG. 15, it is assumed and described that, when the imaging device 100 performs imaging based on imaging conditions, the four still images 1511, 1512, 1513, and 1514 in total are generated and “the image 1511→the image 1512→the image 1513→the image 1514” are sequentially captured. Also, in FIG. 15, it is assumed and described that the second image 1520 is a trajectory image.

The image processor 120 is configured to synthesize the still images 1511, 1512, 1513, and 1514 and to generate the second image 1520. For example, the image processor 120 may generate the second image 1520 based on the synthesis parameter.

The image processor 120 may be configured to extract pixels having the same coordinates from the still images 1511, 1512, 1513, and 1514 and overlay the extracted pixels. For example, the image processor 120 may be configured to extract a pixel corresponding to (x₀, y₀) from each of the images 1511, 1512, 1513, and 1514 and overlay the extracted pixels. In this method, the image processor 120 overlays the pixels having the same coordinates on each other among all pixels included in the still images 1511, 1512, 1513, and 1514. Also, the image processor 120 is configured to combine the overlaid pixels and to generate one second image 1520.

The interface unit 130 outputs the second image 1520. For example, the second image 1520 may be output on a screen included in the interface unit 130.

FIG. 16 is a sequence diagram illustrating an example in which an imaging device operates.

FIG. 16 illustrates an example in which the sensing unit 110, the image processor 120, the interface unit 130 and the processor 140 included in the imaging device 100 operate.

In operation 1610, the interface unit 130 receives the first input. Here, the first input may, for example, refer to an input for setting conditions necessary for the imaging device 100 to capture still images. For example, a gesture may be input to the touch screen and set the above-described conditions or a mouse or a keyboard connected to the imaging device 100 may be used and set the above-described conditions.

Examples in which the interface unit 130 receives the first input are similar to those described above with reference to FIGS. 11 and 12.

In operation 1620, the interface unit 130 transmits imaging condition information to the image processor 120. Operation 1620 is performed only when an input for changing the preset imaging condition is received. For example, when the imaging condition preset in the imaging device is accepted without change, the image processor 120 performs operation 1630 based on the preset imaging condition. For example, the imaging device 100 may output a window asking whether to change the preset imaging condition to the interface unit 130. When an input indicating acceptance of the preset imaging condition is received through the output window, the image processor 120 may perform operation 1630 based on the preset imaging condition.

In operation 1630, the image processor 120 generates still images. For example, the image processor 120 may generate the still images based on the imaging condition. The image processor 120 may also store the generated still images in the memory.

Although not illustrated in FIG. 16, the image processor 120 may continuously generate the live view image before operation 1630 is performed. For example, the imaging device 100 may continuously capture the live view image before still images are captured, and display the captured live view image through the interface unit 130.

An example in which the image processor 120 generates still images is similar to that described with reference to FIG. 13.

In operation 1640, the interface unit 130 receives the second input. Here, the second input may, for example, refer to an input for determining a type of the image representing the moving object. For example, the trajectory image or the point image may be selected through the second input. For example, a gesture to the touch screen may be input to select the trajectory image or the point image, or a mouse or a keyboard connected to the imaging device 100 may be used to select the trajectory image or the point image.

An example in which the interface unit 130 receives the second input is similar to that described with reference to FIG. 14.

In operation 1650, the interface unit 130 transmits type information of the second image to the processor 140. For example, the interface unit 130 transmits information indicating that an image selected is the point image or the trajectory image to the processor 140.

In operation 1660, the processor 140 generates the synthesis parameter. FIG. 16 illustrates an example in which the imaging device 100 generates the point image of the moving object. Therefore, in operation 1660, the processor 140 generates the synthesis parameter for generating the point image.

For example, the processor 140 may generate a synthesis parameter for rotating the still images at a predetermined angle (θ) and overlaying. The predetermined angle (θ) may be determined based on the location information of the imaging device 100. For example, the processor 140 determines a rotation angle (θ) of the moving object with reference to the location information of the imaging device 100, and generates the synthesis parameter based on the determined angle (θ).

For example, it is assumed that “a first still image→a second still image→a third still image” are sequentially captured. According to the synthesis parameter, the second still image is rotated the angle (θ) with respect to the first still image, and the third still image is rotated the angle (θ) with respect to the second still image. Then, in the rotated still images, pixels having the same coordinates may be overlaid and one image may be generated.

It will be appreciated that the above-described example (the example in which the still image rotates at a predetermined angle (θ)) is only an example of the synthesis parameter of generating the point image. For example, there may be various examples in which the synthesis parameter is generated based on a location and a movement direction of the moving object represented in the still images.

The imaging device 100 captures still images at different times while a composition thereof is fixed. Therefore, when still images are rotated and overlaid, an image representing a point image of the moving object may be generated. For example, when the processor 140 generates the synthesis parameter for rotating the still images and then overlaying, the point image of the moving object may be generated.

In operation 1670, the interface unit 130 receives a third input. The third input may, for example, refer to an input of selecting an area (hereinafter referred to as a “non-rotation area”) that is not rotated in the still image. For example, the non-rotation area in the still image may be selected through the third input. For example, a gesture may be input to the touch screen to select the non-rotation area or a mouse or a keyboard connected to the imaging device 100 may be used to select the non-rotation area.

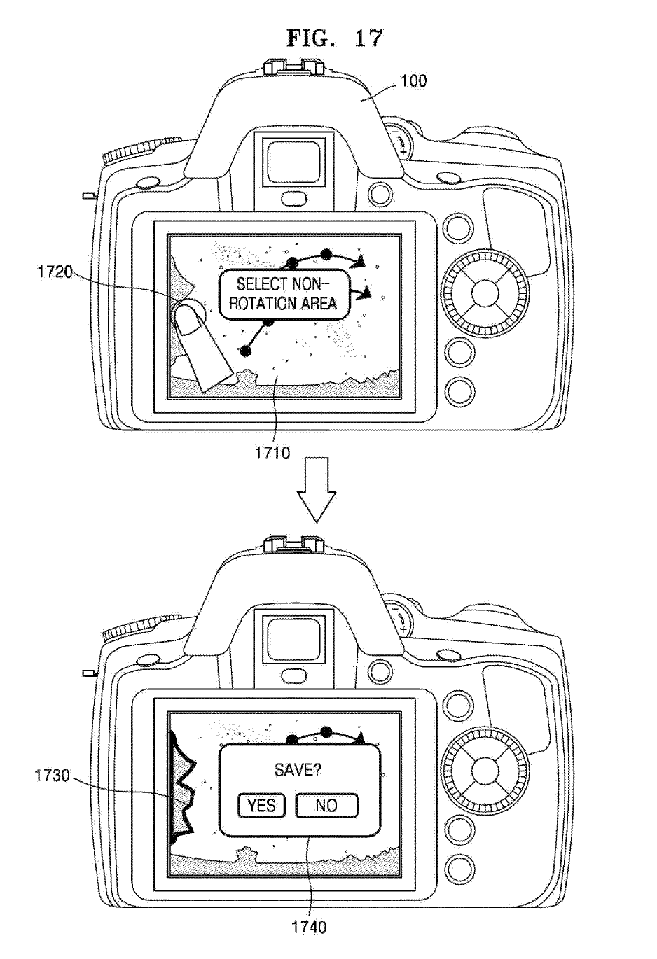

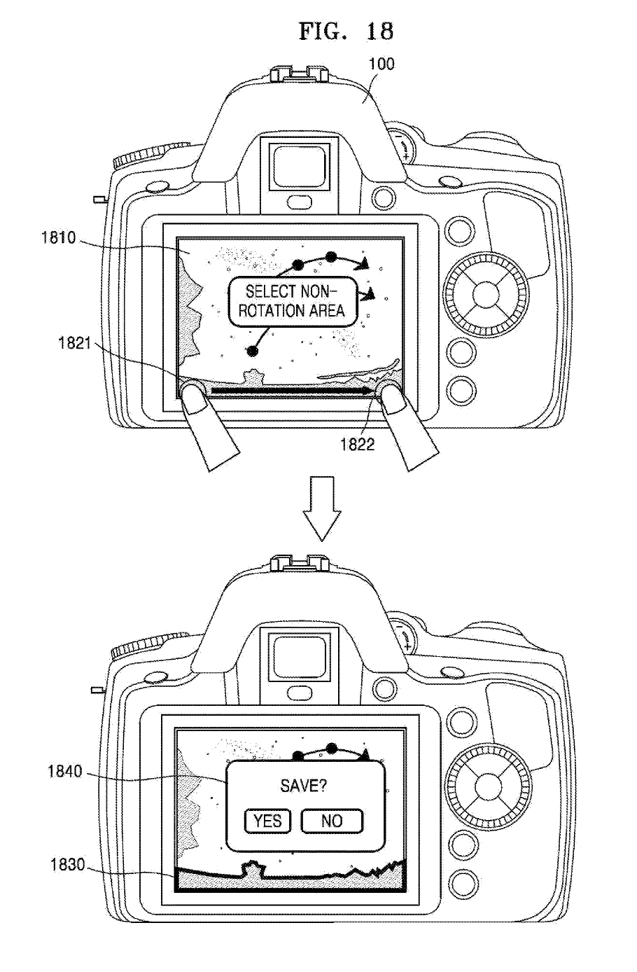

With reference to FIGS. 17 and 18, examples in which the interface unit 130 receives the third input will be described.

FIG. 17 is a diagram illustrating an example in which an interface unit receives an input for selecting a non-rotation area.

A still image 1710 is displayed on the touch screen of the imaging device 100. While the still image 1710 is displayed on the touch screen, a gesture may be performed on the still image 1710 to select the non-rotation area.

For example, when a touch (for example, a tap or a double tap) is applied to one point 1720 of the still image 1710, the imaging device 100 selects pixels having a similar pixel value to a pixel of the touched point 1720 in the still image 1710 from the still image 1710. The imaging device 100 displays an area 1730 formed of the selected pixels on the still image 1710.

The imaging device 100 may display a window 1740 on the touch screen asking whether to store the area 1730. Confirmation of whether the area 1730 is appropriately selected as the non-rotation area may be performed. When “yes” included in the window 1740 is selected, the area 1730 may be stored as the non-rotation area.

FIG. 18 is a diagram illustrating an example in which an interface unit receives an input for selecting a non-rotation area.

Comparing FIGS. 17 and 18, FIG. 18 illustrates an example in which one point 1821 may be dragged to another point 1822 of a still image 1810 and thus the non-rotation area is selected.

For example, the still image 1810 is displayed on the touch screen of the imaging device 100. While the still image 1810 is displayed on the touch screen, a gesture may be performed on the still image 1810 to select the non-rotation area.

For example, when one point 1821 is dragged to another point 1822 of the still image 1810, the imaging device 100 detects pixels corresponding to the dragged area. The imaging device 100 selects pixels having a similar pixel value of the detected pixels from the still image 1810. The imaging device 100 displays an area 1830 formed of the selected pixels on the still image 1810.

The imaging device 100 may display a window 1840 on the touch screen asking whether to store the area 1830. Confirmation of whether the area 1830 is appropriately selected as the non-rotation area may be performed. When “yes” included in the window 1840 is selected, the area 1830 may be stored as the non-rotation area.

Referring again to FIG. 16, in operation 1673, the interface unit 130 transmits information on the selected area to the processor 140. For example, the interface unit 130 transmits information on the non-rotation area to the processor 140.

In operation 1675, the processor 140 defines a rotation area. For example, the processor 140 may define an area other than the non-rotation area in the still image as the rotation area.

In operation 1670, the interface unit 130 may receive the third input selecting the rotation area of the still image. In the operation 1675, the interface unit 130 may define the rotation area corresponding to the third input.

In operation 1680, the processor 140 instructs the image processor 120 to generate the second image. For example, the processor 140 transmits an instruction to synthesize the still images based on the synthesis parameter and to generate the second image to the image processor 120. The processor 140 also transmits information on the rotation area to the image processor 120.

In operation 1690, the image processor 120 generates the second image. For example, the image processor 120 may rotate each of the still images by a predetermined angle (θ), extract pixels having the same coordinates from the rotated still images, overlay the extracted pixels, and generate the second image. The image processor 120 may rotate the rotation area by the predetermined angle (θ) in the still images.

Although not illustrated in FIG. 16, the image processor 120 may store the second image in the memory.

In operation 1693, the image processor 120 transmits the second image to the interface unit 130.

In operation 1695, the interface unit 130 outputs the second image. For example, the second image may be output on a screen included in the interface unit 130.

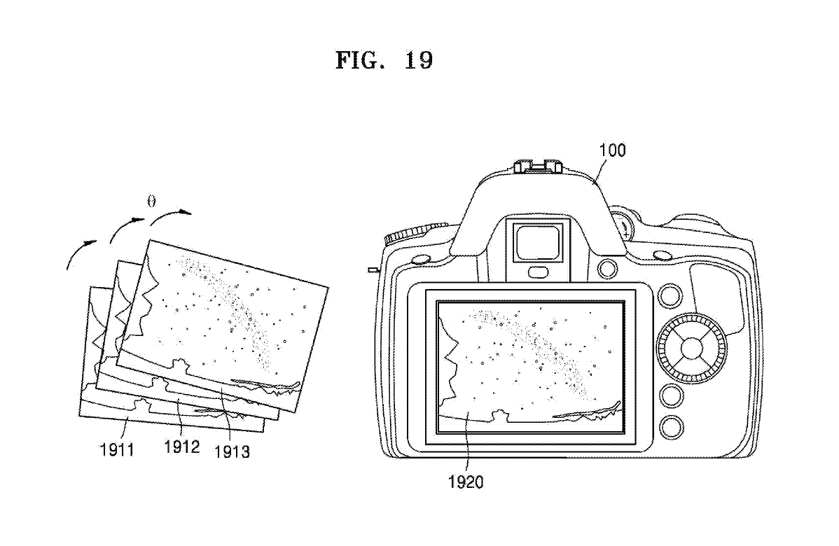

With reference to FIG. 19, the above-described operations 1680 to 1695 will be described in greater detail.

FIG. 19 is a diagram illustrating an example in which a second image is generated.

FIG. 19 illustrates still images 1911, 1912, and 1913 and a second image 1920 generated by the image processor 120. In FIG. 19, it is assumed and described that, when the imaging device 100 performs imaging based on imaging conditions, the three still images 1911, 1912, and 1913 in total are generated and “the image 1911→the image 1912→the image 1913” are sequentially captured. Also, in FIG. 19, it is assumed and described that the second image 1920 is a point image.

The image processor 120 synthesizes the still images 1911, 1912, and 1913 and generates the second image 1920. For example, the image processor 120 may generate the second image 1920 based on the synthesis parameter.

The image processor 120 rotates the image 1912 and the image 1913 by a predetermined angle (θ) based on the synthesis parameter. The image 1913 is further rotated by the angle (θ). The angle (θ) refers to a rotation angle of the moving object for a time interval for which the still images 1911, 1912, and 1913 are captured. For example, when it is assumed that the still images 1911, 1912, and 1913 are captured at the intervals of 3 minutes, the angle (θ) refers to a rotation angle of the moving object after three minutes.

In this case, the image processor 120 may rotate the rotation area in the still images 1911, 1912, and 1913. For example, the image processor 120 may rotate an area other than the non-rotation area in the still images 1911, 1912, and 1913.

The image processor 120 may extract pixels having the same coordinates from the rotated still images and overlay the extracted pixels. For example, the image processor 120 may extract a pixel corresponding to (x₀, y₀) from each of the rotated still images and overlay the extracted pixels. In this manner, the image processor 120 overlays the pixels having the same coordinates on each other among all pixels included in the rotated still images. The image processor 120 combines the overlaid pixels and generates one second image 1920.

The interface unit 130 outputs the second image 1920. For example, the second image 1920 may be output on a screen included in the interface unit 130.

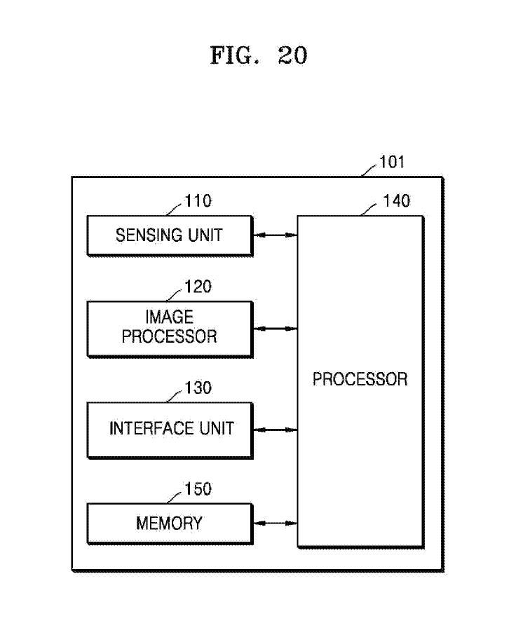

FIG. 20 is a diagram illustrating another example configuration of an imaging device.

As illustrated in FIG. 20, an imaging device 101 further includes a memory 150 in addition to the sensing unit 110, the image processor 120, the interface unit 130, and the processor 140. In the imaging device 101 illustrated in FIG. 20, only components related to the present example are illustrated. Therefore, it will be understood by those skilled in the art that other general-purpose components may be further included in addition to the components illustrated in FIG. 20.

The sensing unit 110, the image processor 120, the interface unit 130 and the processor 140 of the imaging device 101 are similar to the sensing unit 110, the image processor 120, the interface unit 130 and the processor 140 included in the imaging device 100 of FIG. 2. Therefore, detailed descriptions of the sensing unit 110, the image processor 120, the interface unit 130 and the processor 140 will be omitted below.

The memory 150 stores the moving trajectory of the moving object, the first image and the second image. The memory 150 may also store a program for processing of and controlling of the processor 140, and store data input to the imaging device 101 or output from the imaging device 101.

The memory 150 may, for example, include a storage medium of at least one type of a flash memory type, a hard disk type, a multimedia card micro type, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like.

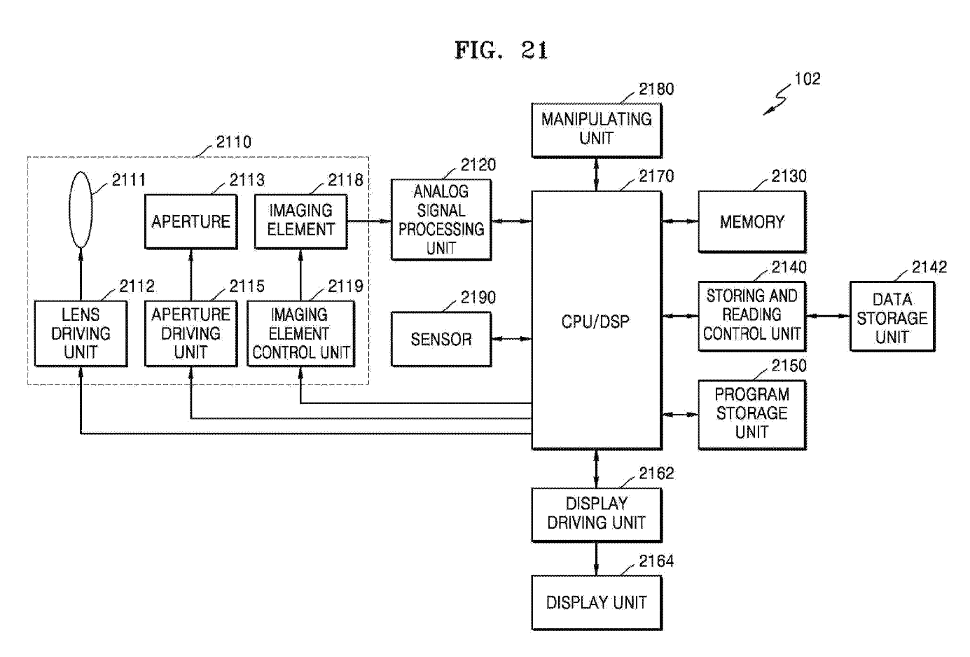

FIG. 21 is a diagram illustrating an example configuration of an imaging device.

An imaging device 102 may include an imaging unit 2110, an analog signal processing unit 2120, a memory 2130, a storing and reading control unit 2140, a data storage unit 2142, a program storage unit 2150, a display driving unit 2162, a display unit 2164, a CPU/DSP 2170 and a manipulating unit 2180.

The imaging device 102 of FIG. 21 includes other modules used to capture an image in addition to modules included in the imaging device 100 of FIG. 2 and the imaging device 101 of FIG. 20.

For example, functions of the sensing unit 110 of FIGS. 2 and 20 may be performed by a sensor 2190 of FIG. 21. Also, functions of the processor 140 and the image processor 120 of FIGS. 2 and 20 may be performed by the CPU/DSP 2170 of FIG. 21. Also, functions of the interface unit 130 of FIGS. 2 and 20 may be performed by the display driving unit 2162, the display unit 2164 and the manipulating unit 2180 of FIG. 21. Also, functions of the memory 150 of FIG. 20 may be performed by the memory 2130, the storing and reading control unit 2140, the data storage unit 2142 and the program storage unit 2150 of FIG. 21.

Overall operations of the imaging device 102 may be generally controlled by the CPU/DSP 2170. The CPU/DSP 2170 is configured to provide a control signal for operating components included in the imaging device 102 such as a lens driving unit 2112, an aperture driving unit 2115, an imaging element control unit 2119, the display driving unit 2162, and the manipulating unit 2180.

The imaging unit 2110 is a component configured to generate an image of an electrical signal from incident light, and includes a lens 2111, the lens driving unit 2112, an aperture 2113, an aperture driving unit 2115, an imaging element 2118, and the imaging element control unit 2119.

The lens 2111 may include a plurality of groups of lenses or a plurality of lenses. The lens 2111 has a location that is adjusted by the lens driving unit 2112. The lens driving unit 2112 adjusts the location of the lens 2111 based on the control signal provided from the CPU/DSP 2170.

The aperture 2113 has an opening degree that is adjusted by the aperture driving unit 2115 and adjusts an amount of light incident on the imaging element 2118.

An optical signal passed through the lens 2111 and the aperture 2113 forms an image of a subject on a light-receiving surface of the imaging element 2118. The imaging element 2118 may, for example, be a charge coupled device (CCD) image sensor or a complementary metal oxide semiconductor image sensor (CIS) configured to convert an optical signal into an electrical signal, or the like. The imaging element 2118 has sensitivity or the like that may be adjusted by the imaging element control unit 2119. The imaging element control unit 2119 may be configured to control the imaging element 2118 based on a control signal that is automatically generated by an image signal input in real time or a control signal that is manually input by manipulation.

A light exposure time of the imaging element 2118 is adjusted by a shutter (not illustrated). The shutter (not illustrated) may, for example, include a mechanical shutter configured to move a cover and adjust incidence of light, and an electronic shutter configured to supply an electrical signal to the imaging element 2118 and control light exposure.

The analog signal processing unit 2120 is configured to perform noise reduction processing, gain adjustment, waveform shaping, analog-digital conversion processing and the like on an analog signal supplied from the imaging element 2118.

The signal that has been processed by the analog signal processing unit 2120 may be input to the CPU/DSP 2170 through the memory 2130 or input to the CPU/DSP 2170 without passing through the memory 2130. The memory 2130 serves as a main memory of the imaging device 102, and temporarily stores information necessary when the CPU/DSP 2170 operates. The program storage unit 2150 stores a program such as an operating system for driving the imaging device 102 and an application system.

In addition, the imaging device 102 includes the display unit 2164 configured to display an operation state thereof or information on an image captured by the imaging device 102. The display unit 2164 may provide visual information and/or audible information to the user. In order to provide visual information, the display unit 2164 may include, for example, a liquid crystal display panel (LCD) or an organic light emitting display panel, or the like.

Also, the imaging device 102 may include two or more display units 2164, and the display unit 2164 may, for example, be a touch screen capable of recognizing a touch input. For example, the imaging device 102 may include a display unit configured to display a live view image that represents a target to be imaged and a display unit configured to display an image that represents a state of the imaging device 102.

The display driving unit 2162 provides a driving signal to the display unit 2164.

The CPU/DSP 2170 is configured to process the input image signal, and to control components accordingly or according to an external input signal. The CPU/DSP 2170 may be configured to perform image signal processing for image quality improvement on the input image data such as noise reduction, gamma correction, color filter array interpolation, a color matrix, color correction, and color enhancement. Also, an image file may be generated by compressing the image data generated through the image signal processing for image quality improvement, or image data may be restored from the image file. A compression format of the image may be a reversible format or an irreversible format. As an example of an appropriate format, a still image may be converted into a Joint Photographic Experts Group (JPEG) format or a JPEG 2000 format. When a video is recorded, a video file may be generated by compressing a plurality of frames according to a Moving Picture Experts Group (MPEG) standard. The image file may be generated according to, for example, an Exchangeable image file format (Exif) standard.

The image data output from the CPU/DSP 2170 is input to the storing and reading control unit 2140 through the memory 2130 or directly. The storing and reading control unit 2140 stores the image data in the data storage unit 2142 according to an input signal or automatically. Also, the storing and reading control unit 2140 may read data related to the image from the image file stored in the data storage unit 2142, input the read data to the display driving unit through the memory 2130 or other paths, and thus the image may be displayed on the display unit 2164. The data storage unit 2142 may be detachable or permanently mounted on the imaging device 102.

The CPU/DSP 2170 may also be configured to perform sharpness processing, color processing, blur processing, edge enhancement processing, image analyzing processing, image recognition processing, image effect processing or the like. As the image recognition processing, face recognition, scene recognition processing or the like may be performed. In addition, the CPU/DSP 2170 may be configured to perform display image signal processing for performing displaying on the display unit 2164. For example, brightness level adjustment, color correction, contrast adjustment, edge enhancement adjustment, screen division processing, generation of a character image or the like, an image synthesizing process, or the like may be performed. The CPU/DSP 2170 may be connected to an external monitor and may perform predetermined image signal processing such that an image is displayed on the external monitor. The image data processed in this manner may be transmitted and thus the image may be displayed on the external monitor.

Also, the CPU/DSP 2170 may be configured to generate a control signal for controlling autofocusing, zoom changing, focus changing, auto exposure correction or the like by executing a program stored in the program storage unit 2150 or through a separate module, to provide the signal to the aperture driving unit 2115, the lens driving unit 2112, and the imaging element control unit 2119, and to generally control operations of components of the imaging device 102 such as a shutter and a strobe.

The manipulating unit 2180 is configured such that a control signal can be input. The manipulating unit 2180 may include various function buttons such as a shutter-release button configured to input a shutter-release signal causing the imaging element 2118 to be exposed to light for a determined time to take a picture, a power button configured to input a control signal for controlling power on and off, a zoom button configured to increase or decrease an angle of view according to an input, a mode selection button, and other imaging setting value adjusting buttons. The manipulating unit 2180 may be implemented in any form through which the user is able to input a control signal such as a button, a keyboard, a touchpad, a touch screen, or a remote controller.

The sensor 2190 may measure a physical quantity or detect an operation state of the imaging device 102, and convert the measured or detected information into an electrical signal. An example of the sensor 2190 that may be included in the imaging device 102 is the same as that described with reference to the sensing unit 110 of FIG. 2. The sensor 2190 may further include a control circuit configured to control at least one sensor included therein. In some embodiments, the imaging device 102 may further include a processor that is provided as a part of the CPU/DSP 2170 or a separate component and is configured to control the sensor 2190, and may control the sensor 2190 while the CPU/DSP 2170 is in a sleep state.

The imaging device 102 illustrated in FIG. 21 is an example in which components necessary for performing imaging are illustrated. The imaging device 102 according to the example is not limited to the imaging device 102 illustrated in FIG. 21.

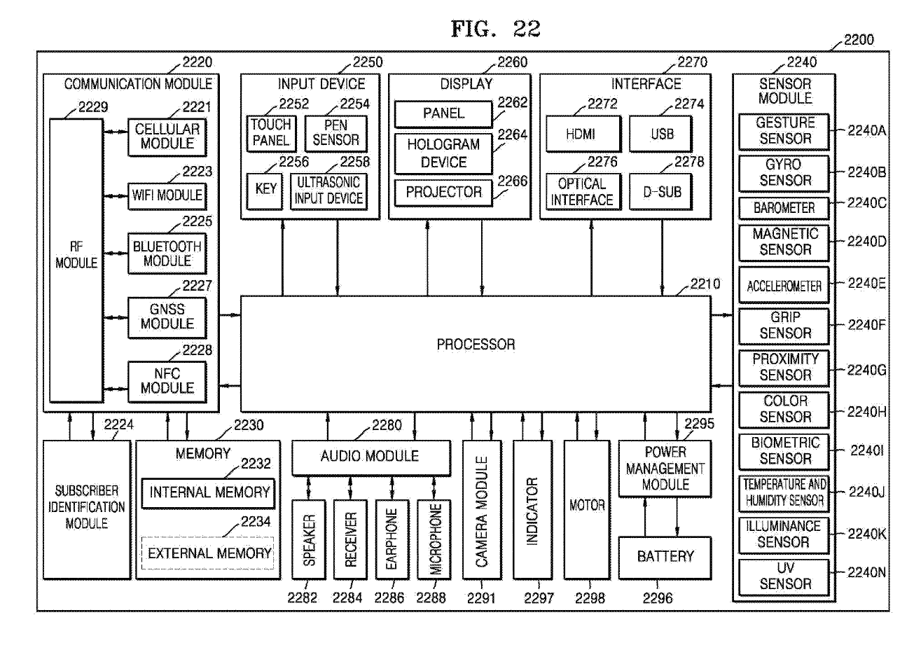

FIG. 22 is a diagram illustrating another example configuration of an imaging device.

For example, an electronic device 2200 may include all or some of the imaging devices 100 and 101 illustrated in FIGS. 2 and 20. The electronic device 2200 may include at least one processor (for example, a CPU/DSP or an application processor (AP) 2210, a communication module 2220, a subscriber identification module 2224, a memory 2230, a sensor module 2240, an input device 2250, a display 2260, an interface 2270, an audio module 2280, a camera module 2291, a power management module 2295, a battery 2296, an indicator 2297, and a motor 2298.

The electronic device 2200 of FIG. 22 also includes other modules used to capture an image in addition to modules included in the imaging device 100 of FIG. 2 and the imaging device 101 of FIG. 20.

For example, functions of the sensing unit 110 of FIGS. 2 and 20 may be performed by the sensor module 2240 of FIG. 22. Functions of the processor 140 and the image processor 120 of FIGS. 2 and 20 may be performed by the processor 2210 of FIG. 22. Functions of the interface unit 130 of FIGS. 2 and 20 may be performed by the communication module 2220, the display 2260 and the interface 2270 of FIG. 22. Functions of the memory 150 of FIG. 20 may be performed by the memory 2230 of FIG. 22.

The processor 2210 may be configured to drive, for example, an operating system or an application, to control a plurality of hardware or software components connected to the processor 2210, and to perform various types of data processing and computation. The processor 2210 may be implemented as, for example, a system on chip (SoC). According to an example, the processor 2210 may further include a graphic processing unit (GPU) and/or an image signal processor. The processor 2210 may include at least some (for example: a cellular module 2221) of components illustrated in FIG. 22. The processor 2210 may be configured to load and process a command or data received from at least one of other components (for example, a non-volatile memory) in a volatile memory, and to store various pieces of data in the non-volatile memory.

The communication module 2220 may include, for example, the cellular module 2221, a WiFi module 2223, a Bluetooth module 2225, a GNSS module 2227 (for example, a GPS module, a Glonass module, a Beidou module, or a Galileo module), an NFC module 2228 and a radio frequency (RF) module 2229.

The cellular module 2221 may provide, for example, a voice call, a video call, a short message service, or an Internet service, via a communication network. According to an example, the cellular module 2221 may use the subscriber identification module (for example, an SIM card) 2224, and distinguish and authenticate the electronic device 2200 in the communication network. According to an example, the cellular module 2221 may perform at least some of functions that may be provided by the processor 2210. According to an example, the cellular module 2221 may include a communication processor (CP).

The WiFi module 2223, the Bluetooth module 2225, the GNSS module 2227 and the NFC module 2228 each may include, for example, a processor configured to process data that is transmitted and received through a corresponding module. According to an example, at least two (for example, two or more) of the cellular module 2221, the WiFi module 2223, the Bluetooth module 2225, the GNSS module 2227 and the NFC module 2228 may be included in one integrated chip (IC) or an IC package.

The RF module 2229 may transmit and receive, for example, a communication signal (for example, an RF signal). The RF module 2229 may include, for example, a transceiver, a power amp module (PAM), a frequency filter, a low noise amplifier (LNA), or an antenna. According to another example, at least one of the cellular module 2221, the WiFi module 2223, the Bluetooth module 2225, the GNSS module 2227 and the NFC module 2228 may transmit and receive the RF signal through a separate RF module.

The subscriber identification module 2224 may include, for example, a card including a subscriber identification module and/or an embedded SIM, and may include unique identification information (for example, an integrated circuit card identifier (ICCID)) or subscriber information (for example, an international mobile subscriber identity (MI)).

The memory 2230 may include, for example, an internal memory 2232 or an external memory 2234. The internal memory 2232 may include, for example, at least one of a volatile memory (for example, a dynamic RAM (DRAM), a static RAM (SRAM), or a synchronous dynamic RAM (SDRAM)), a non-volatile memory (for example, one time programmable ROM (OTPROM), a programmable ROM (PROM), an erasable and programmable ROM (EPROM), an electrically erasable and programmable ROM (EEPROM), a mask ROM, a flash ROM, a flash memory (for example, a NAND flash or an NOR flash), a hard drive, and a solid state drive (SSD).

The external memory 2234 may further include a flash drive, for example, a compact flash (CF), a secure digital (SD) card, a micro-secure digital (micro-SD) card, a mini secure digital (mini-SD) card, an extreme digital (xD) card, a multi-media card (MMC) or a memory stick. The external memory 2234 may be functionally and/or physically connected to the electronic device 2200 through various interfaces.

The sensor module 2240 may, for example, measure a physical quantity or detect an operation state of the electronic device 2200, and convert the measured or detected information into an electrical signal. The sensor module 2240 may include, for example, at least one of a gesture sensor 2240A, a gyro sensor 2240B, a barometer 2240C, a magnetic sensor 2240D, an accelerometer 2240E, a grip sensor 2240F, a proximity sensor 2240G, a color sensor 2240H (for example, an RGB (red, green, blue) sensor), a biometric sensor 2240I, a temperature and humidity sensor 2240J, an illuminance sensor 2240K, and an ultraviolet (UV) sensor 2240M. Additionally and alternatively, the sensor module 2240 may include, for example, an olfactory sensor (E-nose sensor), an electromyography (EMG) sensor, an electroencephalogram (EEG) sensor, an electrocardiogram (ECG) sensor, an infrared (IR) sensor, an iris sensor and/or a fingerprint sensor. The sensor module 2240 may further include a control circuit configured to control at least one sensor included therein. In some examples, the electronic device 2200 may further include a processor that is provided as a part of the processor 2210 or a separate component and is configured to control the sensor module 2240, and may control the sensor module 2240 while the processor 2210 is in a sleep state.

The input device 2250 may include, for example, a touch panel 2252, a (digital) pen sensor 2254, a key 2256, or an ultrasonic input device 2258. The touch panel 2252 may use, for example, at least one of a capacitive method, a resistive method, an infrared method and an ultrasound method. Also, the touch panel 2252 may further include a control circuit. The touch panel 2252 may further include a tactile layer and provide a tactile response to the user.

The (digital) pen sensor 2254 may include, for example, a recognition sheet that is a part of the touch panel or a separate sheet. The key 2256 may include, for example, a physical button, an optical key, or a keypad. The ultrasonic input device 2258 may detect an ultrasound generated from an input device through a microphone (for example, a microphone 2288) and check data corresponding to the detected ultrasound.

The display 2260 may include a panel 2262, a hologram device 2264, or a projector 2266. The panel 2262 may be implemented, for example, to be flexible, transparent, or wearable. The panel 2262 and the touch panel 2252 may be configured as one module. The hologram device 2264 may use interference of light and provide a stereoscopic image in midair. The projector 2266 may project light to a screen and display an image. The screen may be located, for example, inside or outside the electronic device 2200. According to an example, the display 2260 may further include a control circuit configured to control the panel 2262, the hologram device 2264, or the projector 2266.

The interface 2270 may include, for example, a high-definition multimedia interface (HDMI) 2272, a Universal Serial Bus (USB) 2274, an optical interface 2276, or a D-subminiature (D-sub) 2278. Additionally and alternatively, the interface 2270 may include, for example, a mobile high-definition link (MHL) interface, a secure digital (SD) card/multi-media card (MMC) interface, or an infrared data association (IrDA) compliant interface.

The audio module 2280 may interactively convert, for example, between a sound and an electrical signal. The audio module 2280 may process sound information input or output through, for example, a speaker 2282, a receiver 2284, an earphone 2286, or the microphone 2288.

The camera module 2291 is a device capable of capturing, for example, a still image and a video. According to an example, the camera module 2291 may include at least one image sensor (for example, a front sensor or a rear sensor), a lens, an image signal processor (ISP), or a flash (for example, an LED or a xenon lamp).

The power management module 2295 may be configured to manage, for example, power of the electronic device 2200. According to an example, the power management module 2295 may include a power management integrated circuit (PMIC), a charger integrated circuit (IC) or a battery or a fuel gauge. The PMIC may include a wired and/or wireless charging method. The wireless charging method includes, for example, a magnetic resonance method, a magnetic induction method or an electromagnetic method, and may further include an additional circuit for wireless charging, for example, a coil loop, a resonant circuit, or a rectifier. The battery gauge may measure, for example, a remaining amount of the battery 2296, a temperature, a current and a voltage during charging. The battery 2296 may include, for example, a rechargeable battery and/or a solar battery.

The indicator 2297 may display a specific state of the electronic device 2200 or a part thereof (for example, the processor 2210), for example, a booting state, a message state or a charging state. The motor 2298 may convert an electrical signal into mechanical vibration, and generate vibration, a haptic effect or the like. Although not illustrated in FIG. 22, the electronic device 2200 may include a processing device (for example, a GPU) for supporting a mobile TV. The processing device for supporting a mobile TV may process media data according to, for example, a standard such as digital multimedia broadcasting (DMB), digital video broadcasting (DVB), or mediaFlo™.

Elements described herein each may be configured as one or more components, and a name of the element may be changed according to a type of the electronic device. In various examples, the electronic device may include at least one of elements described herein and some elements may be omitted or additional other elements may be further included. Also, some of the elements of the electronic device according to various examples may be combined and form one entity, and thus functions of the elements before combination may be performed in the same manner.

According to the above description, the imaging device may image the moving object while the imaging device is fixed. The imaging device may image the moving object without requiring a combination with an expensive device (for example, the equatorial telescope mount or the piggyback mount). The image the moving object using the imaging device without a prior knowledge of the moving trajectory of the moving object may be easily achieved.

Meanwhile, the above-described method may be written as a program that may be executed in a computer, and may be implemented in a digital computer that operates the program using a computer readable recording medium. Also, a structure of data used in the above-described method may be recorded in the computer readable recording medium through several methods. The computer readable recording medium includes a storage medium such as a magnetic storage medium (for example, a ROM, a RAM, a USB, a floppy disk, and a hard disk), and an optical reading medium (for example, a CD ROM and a DVD).

Also, the above-described method may be performed by executing instructions included in at least one program among programs stored in the computer readable recording medium. When the instructions are executed by the computer, the at least one computer may perform a function corresponding to the instructions. The instructions may include a machine code generated by a compiler and a high-level language code that may be executed in the computer using an interpreter. In this disclosure, an example computer may be a processor and an example recording medium may be a memory.

It will be understood by those skilled in the art that various changes may be made without departing from the spirit and scope of the disclosure. Therefore, the disclosed methods should be considered in a descriptive sense only and not for purposes of limitation. The scope of the disclosure is defined not by the above description but by the appended claims, and encompasses all modifications and equivalents that fall within the scope of the appended claims and will be construed as being included in the disclosure.

What is claimed is:

1. An imaging device configured to image a moving object, the imaging device comprising:
a sensor configured to obtain location information of the imaging device;
a processor configured to determine a moving trajectory of the moving object using the location information;
an interface configured to output a first image representing the moving trajectory; and
an image processor configured to generate the first image and to generate a second image representing the moving object based on the moving trajectory.

2. The imaging device of claim 1,
wherein the second image includes at least one of: an image representing a moving trajectory of a star and an image representing a point image of the star.

3. The imaging device of claim 1,
wherein the image processor is configured to generate the first image by displaying the moving trajectory on a live view image including the moving object.

4. The imaging device of claim 1,
wherein the image processor is configured to generate the second image by combining still images captured based on a predetermined time interval and a predetermined exposure time.

5. The imaging device of claim 4,
wherein the interface receives an input setting at least one of the time interval and the exposure time.

6. The imaging device of claim 1,
wherein the interface is configured to output a live view image including the moving object and to receive an input selecting a first area in the live view image.

7. The imaging device of claim 6,
wherein the image processor is configured to select second areas other than the first area from still images including the moving object, and to generate the second image by synthesizing the second areas.

8. The imaging device of claim 6,
wherein the image processor is configured to select second areas other than the first area from still images including the moving object, to rotate the second areas in each of the still images based on the moving trajectory, and to generate the second image by synthesizing the rotated second areas.

9. The imaging device of claim 1,
wherein the processor is configured to determine the moving trajectory of the moving object using the location information received from an external device.

10. The imaging device of claim 1, further comprising
a memory configured to store the moving trajectory, the first image and the second image.

11. A method of imaging a moving object using an imaging device, comprising:
obtaining location information of the imaging device;
determining a moving trajectory of the moving object using the location information;
outputting a first image representing the moving trajectory; and
generating a second image representing the moving object based on the moving trajectory.

12. The method of claim 11,
wherein the second image includes at least one of: an image representing a moving trajectory of a star and an image representing a point image of the star.

13. The method of claim 11, further comprising
generating the first image by displaying the moving trajectory on a live view image including the moving object.

14. The method of claim 11, further comprising
generating the second image by combining still images captured based on a predetermined time interval and a predetermined exposure time.

15. The method of claim 14, further comprising
receiving an input setting at least one of the time interval and the exposure time.

16. The method of claim 11, further comprising
receiving an input selecting a first area in a live view image including the moving object.

17. The method of claim 16, further comprising
selecting second areas other than the first area in still images including the moving object,
wherein, in generating the second image, the second image is generated by synthesizing the second areas.

18. The method of claim 16, further comprising
selecting second areas other than the first area in still images including the moving object; and
rotating the second areas in each of the still images based on the moving trajectory,
wherein, in generating the second image, the second image is generated by synthesizing the rotated second areas.

19. The method of claim 11,
wherein, in determining the moving trajectory, the moving trajectory of the moving object is determined using the location information received from an external device.

20. A non-transitory computer readable recording medium having stored thereon a computer program which, when executed by a computer, performs the method of claim 11.
